(19) United States
(12) Patent Application Publication
(10) Pub. No.: US 2009/0165282 A1
(43) Pub. Date: Jul. 2, 2009

(54) Method of manufacturing a bezel for LCD/LED panel

(76) Inventor: Shu-Shan Tseng, Taipei (TW)

Correspondence Address: Meng-Tsuey Pan, P.O. Box 1-252, Sanchung, TW

(21) Appl. No.: 12/011,752

(22) Filed: Jan. 30, 2008

(30) Foreign Application Priority Data
Dec. 28, 2007 (TW) 096150693

(51) Int. Cl. B23P 11/00; B23P 15/00

(52) U.S. Cl. 29/460; 29/428

(57) ABSTRACT

A method of manufacturing a bezel for LCD/LED panel comprises the first step of material feeding, wherein a roll of wide metal material is fed intermittently and cut into rectangular metal-plate components, and two rolls of narrow metal material with an appropriate spacing therebetween are fed to a welding table; each of the rectangular metal-plate components is tightly welded at two ends thereof with inner edges of the two rolls of narrow metal material respectively; cutting is executed to produce a planar frame at an interval of an appropriate distance within which one or two rectangular metal-plate components are welded, and then inner and outer edges of the planar frame are squarely trimmed to conform to correct dimensions and shape; lastly, outer margins of the planar frame are pressed and bent downward to form bent portions, thereby completing a final product of the bezel for LCD/LED panel.

### BACKGROUND OF THE INVENTION

1. Field of the Invention

The present invention relates to a method of manufacturing a bezel for liquid crystal display/light emitting diode (LCD/LED) panel, and more particularly, to a method of manufacturing a bezel for LCD/LED panel by consecutive processing procedure to fabricate a bezel, and the finished products are not prone to be twisted or deformed.

2. Description of the Prior Art

Two advanced methods for manufacturing an LCD bezel are disclosed in Taiwan Patents No. 1252727 and M260081 respectively, wherein a roll of metal material is stamped into two L-shaped workpieces or four elongate workpieces, which are then butt-welded to form a planar frame, and after that, outer margins of the planar frame are pressed and bent to form downward portions, and thereby complete a final product of an LCD bezel.

The methods for manufacturing an LCD bezel disclosed in the two patents cited above can save a considerable amount of material cost because an LCD bezel is not made by stamping a large metal-plate to remove a central portion thereof and then stamping the resulting frame to form the bezel. However, in the processes for manufacturing the LCD bezel disclosed in the two patents, a roll of metal material is first stamped into two L-shaped workpieces or four elongate workpieces, which are then butt-welded to produce a planar frame for further forming. As a result, the planar frame is prone to be twisted and deformed seriously. While there is a trimming step in those methods, defective products of LCD bezel that are twisted or deformed may still likely occur. This is one of the serious drawbacks of the two methods.

Furthermore, in the methods disclosed in the two patents cited above, before the LCD bezel is formed by stamping, a roll of metal material must first be stamped into two L-shaped workpieces or four elongate workpieces, which are then butt-welded to produce a planar frame for further forming. Therefore, workers are required to process the workpieces on different machines as well as transporting the workpieces to and from different machines. As a result, it is inconvenient or even impossible to produce by consecutive processing procedure. Although the methods in those two patents can reduce the cost of material, wages for workers are significantly increased. Now that wage levels are soaring in these days, those methods cannot reduce production cost. This is another drawback of the two methods.

In view of the aforementioned problems associated with the conventional methods for manufacturing an LCD bezel, the inventor of the present invention researched and experimented to find ways of improvement and finally developed a method of manufacturing a bezel for LCD/LED panel as disclosed herein.

### SUMMARY OF THE INVENTION

An objective of the invention is to provide a method of manufacturing a bezel for LCD/LED panel whose processing steps can be integrated into a line production and the products of the bezel for LCD/LED panel are not easily twisted and deformed.

To achieve the objective of the invention, a method of manufacturing a bezel for LCD/LED panel comprises the first step of material feeding, wherein a roll of wide metal material is fed intermittently and cut into rectangular metal-plate components, and then two rolls of narrow metal material which are parallel to each other with an appropriate spacing therebetween are fed to a welding table; each of the rectangular metal-plate components is tightly welded at two ends thereof with the adjacent inner edges of the two rolls of narrow metal material respectively; then, cutting is executed after one or two rectangular metal-plate components are welded at an interval of an appropriate distance, so as to produce a planar frame, and the inner and outer edges of the frame are squarely trimmed to conform to the correct dimensions and shape; the last step is forming, wherein outer margins of the planar frame are pressed and bent downward to form bent portions, thereby completing a final product of a bezel for LCD/LED panel.

### BRIEF DESCRIPTION OF THE DRAWINGS

FIG. 1 is a flow chart of manufacturing a bezel for LCD/LED panel according to the present invention.

FIG. 2 is a schematic plan view showing the steps of material feeding and welding of the method of manufacturing a bezel for LCD/LED panel according to the present invention.

FIG. 3 is a plan view of a planar frame cut according to the method of the present invention.

FIG. 4 is a perspective view to show a finished product of the bezel manufactured according to the method of the present invention.

### DETAILED DESCRIPTION OF THE PREFERRED EMBODIMENT

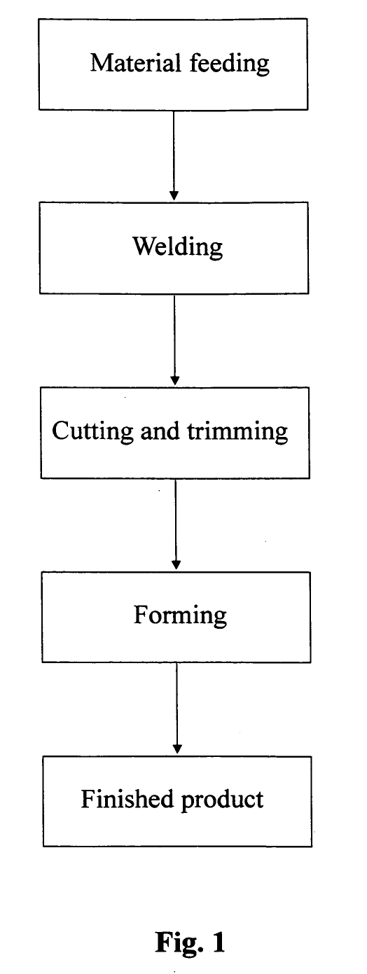

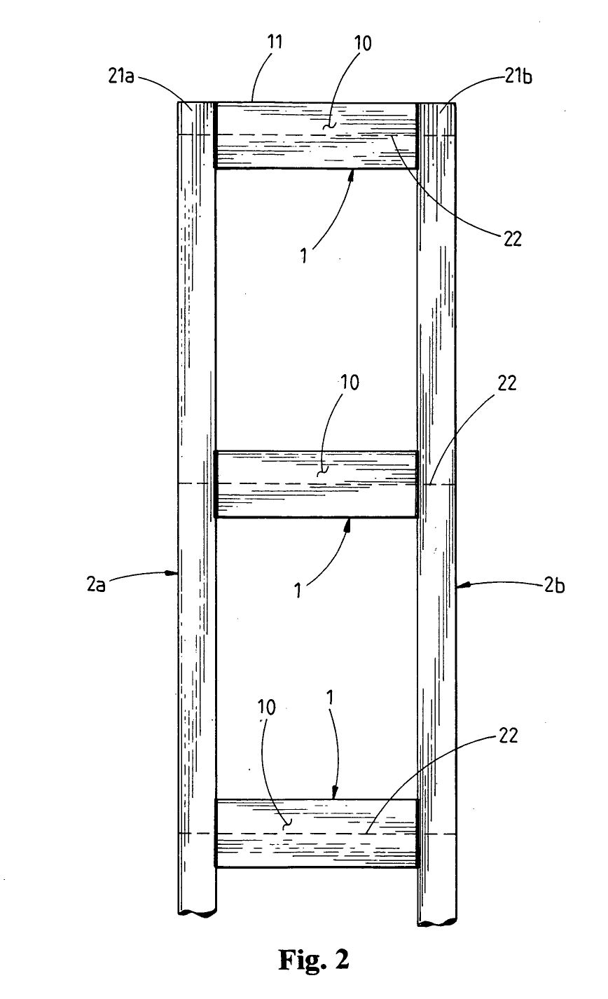

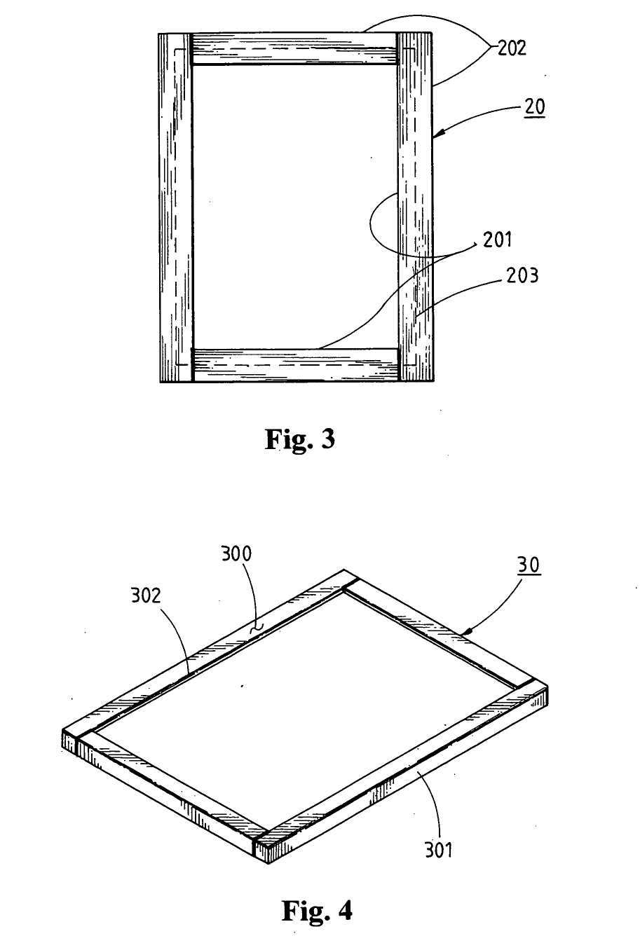

Referring to FIG. 1, a method of manufacturing a bezel for LCD/LED panel according to the present invention comprises the steps of material feeding, welding, cutting and trimming, and forming, wherein the steps of material feeding and welding are shown in FIG. 2. As illustrated in FIG. 2, a roll of wide metal material is fed intermittently and cut by a cutting machine, a press or the like into rectangular metal-plate components 1 having an appropriate width for later use. Then, two rolls of narrow metal material 2a and 2b are fed by an automatic feeder to a welding table (not shown in the drawing), wherein the two rolls of narrow metal material 2a and 2b are parallel to each other with an appropriate spacing therebetween. In the welding step that follows, each of the rectangular metal-plate components 1 is, at an interval of an appropriate distance, tightly welded at two ends thereof with adjacent inner edges of the two rolls of narrow metal material 2a and 2b, respectively. Next, in the cutting and trimming step, cutting is executed along a dotted line 22 in FIG. 2 by an automatic cutting machine, a press or the like, after one or two rectangular metal-plate components 1 are welded at the interval of an appropriate distance, so as to produce a planar frame 20, and then the inner edges 201 and outer edges 202 of the frame 20 are squarely trimmed to conform to correct dimensions and shape. And lastly, in the forming step, outer margins of the planar frame 20 are pressed and bent downward along a dotted-line rectangle 203 in FIG. 3 by a press, an oil hydraulic press or the like to form a frame 300 with bent portions 301, as shown in FIG. 4, thereby completing a final product of a bezel 30 for LCD/LED panel.

As shown in FIG. 4, the frame 300 of the bezel 30 has a window opening 302 in a central portion thereof, wherein the window opening 302 is slightly smaller than an LCD/LED panel, so that the LCD/LED panel is visible through the window opening 302 during assembly.

To prevent welded joints of the bezel from rusting, an anti-rusting step can be added to the method of the present invention, wherein an inner side and an outer side of each of the welded joints are coated with an antirust agent or an antirust paint after the finished product of the bezel is cleaned.

In the method of manufacturing a bezel for LCD/LED panel according to the present invention, scraps are produced only when a first cutting and a last cutting are executed. More particularly, referring to FIG. 2, when the first cutting is executed, a first half portion 11 of a plate body 10 of a first rectangular metal-plate component 1 is cut and discarded along with foremost ends 21a and 21b of the two rolls of narrow metal material 2a and 2b which are approximately as long as a width of the first half portion 11. When the last cutting is executed, a last half portion (not shown) of a plate body 10 of a last rectangular metal-plate component 1 is cut and discarded along with rearmost ends (not shown) of the two rolls of narrow metal material 2a and 2b. In other words, except for the discarded portions, all the metal material is properly used. Therefore, the method of manufacturing a bezel for LCD/LED panel according to the present invention can save more material than conventional methods. Moreover, the method of manufacturing a bezel for LCD/LED panel is more suitable, by consecutive processing procedure or automated processing to form a bezel for LCD/LED panel. Consequently, workers' wages can be considerably saved to lower production cost.

The preferred embodiment mentioned above is intended for illustrative purpose only and is not meant to restrict the present invention. Any modifications or changes to the embodiment are within scope and spirit of the present invention. The scope of the invention is set forth by the claims below.

What is claimed is:

1. A method of manufacturing a bezel for liquid crystal display/light emitting diode (LCD/LED) panel comprising the steps of:
material feeding, wherein a roll of wide metal material is fed intermittently and cut into rectangular metal-plate components, and then two rolls of narrow metal material which are parallel to each other with an appropriate spacing therebetween are fed to a welding table;
welding in such a manner that each of the rectangular metal-plate components is tightly welded at two ends thereof with adjacent inner edges of the two rolls of narrow metal material respectively;
cutting into a planar frame after one or two rectangular metal-plate components being welded at an interval of an appropriate distance;
trimming inner and outer edges of the planar frame to conform to correct dimensions and shape; and
forming bent portions by having outer margins of the planar frame pressed and bent downward to complete a finished product of a bezel for LCD/LED panel.

2. The method of manufacturing a bezel for LCD/LED panel of claim 1 further comprising an anti-rusting step, wherein an inner side and an outer side of the two ends of the rectangular metal-plate components are coated with an antirust agent or an antirust paint after the finished product of the bezel is cleaned.
